(19) United States
(12) Patent Application Publication
(10) Pub. No.: US 2025/0274684 A1
(43) Pub. Date: Aug. 28, 2025

(54) OPTICAL VIRTUAL-CIRCUIT-SWITCHING NETWORK SYSTEM AND OPTICAL SWITCH THEREOF

(71) Applicant: GeNopsys Technologies, Inc., Dover, DE (US)

(72) Inventors: Chi-Jui Maria YUANG, Hsinchu (TW); Shan ZHONG, Clarksville, MD (US); Po-Lung TIEN, Hsinchu County (TW)

(21) Appl. No.: 19/040,996

(22) Filed: Jan. 30, 2025

Related U.S. Application Data
(60) Provisional application No. 63/556,488, filed on Feb. 22, 2024.

(51) Int. Cl. H04Q 11/00

(52) U.S. Cl. CPC H04Q 11/0005; H04Q 2011/0015

(57) ABSTRACT

The optical virtual-circuit-switching network system includes a plurality of optical switches, each including an optical upload module, an optical download module, an optical pass-around module, and an optical fiber connection module. The optical upload module receives uploaded optical signals from the top-of-rack switch, selects the appropriate route and wavelength, and then transmits them to the optical fiber connection module. These signals are then transmit through the optical fiber connection module to the vertically connected optical switch or horizontally connected optical switch. The optical download module receives the optical signals from the vertically connected optical switch and the horizontally connected optical switch, selects and combines these optical signals so as to download them to the top-of-rack switch. The optical pass-around module, along with the optical fiber connection module, is used to redirect the optical signals from horizontal to vertical or from vertical to horizontal.

### CROSS-REFERENCES TO RELATED APPLICATIONS

This application claims the benefit of U.S. Provisional Application Ser. No. 63/556,488 filed on Feb. 22, 2024. The entirety of each Application is incorporated herein by reference.

### BACKGROUND OF THE INVENTION

### Field of the Invention

The present invention relates to an optical virtual-circuit-switching network system and its optical switches for HPC network infrastructure, particularly to an optical virtual-circuit-switching network system that enables dynamic selections for routing and wavelength of optical signals, called optical thruways, for rack-to-rack optical interconnections.

### Descriptions of the Related Art

High-performance computing (HPC) refers to the use of extremely powerful computer systems for large-scale and complex data processing. HPC is widely applied in fields such as artificial intelligence (AI), machine learning (ML), large-scale natural language processing (e.g., ChatGPT), financial analysis, medical data analytics, and big data processing. These systems demand exceptional computational capabilities and extremely high data transmission rates.

Currently, HPC systems are evolving toward higher performance, reduced power consumption, and improved efficiency, leveraging advanced interconnection technologies to enable rapid data transfer and real-time processing among computing nodes. To meet these demands, HPC systems rely on data center network infrastructures that flexibly provide high-bandwidth and ultra-low-latency interconnections between servers.

Virtual circuit switching is a packet-switching method in the electrical domain. It establishes a path between the source and the destination for enabling packets to be routed and electrically switched along this path, which is referred to as a virtual circuit. The term “circuit” indicates that all packets in a specific data flow are transmitted along a predetermined path to ensure a stable connection for the end user. Meanwhile, “virtual” signifies that this path is shared with other data flows rather than exclusively dedicated to the data flow.

However, the limitations of conventional electronic switching networks in handling rapidly growing data volumes and demanding high-speed processing are becoming increasingly apparent and posing significant challenges for HPC systems. One major challenge lies in the interface between electronic switches and optical fibers, which relies on optical transceivers. Frequent optical-to-electrical-to-optical (O/E/O) signal conversions lead to high-power consumption in both network switching equipment and photoelectric conversion processes. Consequently, overall operational costs increase significantly. Moreover, as data volumes and processing demands grow, electronic switching infrastructures face bottlenecks in bandwidth scalability, and high end-to-end latency further degrades overall system performance.

In view of the above, the present invention proposes an optical virtual-circuit-switching network system and its optical switches to resolve the challenges of high-power consumption, excessive latency, and elevated costs in existing technologies.

### SUMMARY OF THE INVENTION

An objective of the present invention is to provide an optical virtual-circuit-switching network system and its optical switches. The optical virtual-circuit-switching network system comprises a plurality of optical switches and a plurality of top-of-rack (ToR) switches. A key feature of the invention is that each optical switch integrates amplifiers, splitters, couplers, and wavelength-selective switches, forming an optical upload module, an optical pass-around module, an optical download module, and an optical fiber connection module. Multiple server racks, each equipped with a corresponding ToR switch and optical switch, are interconnected through horizontal and vertical optical network subsystems formed by horizontally and vertically connected optical switches, enabling seamless communication between server racks. Packet traffic received from the ToR switches is fully transmitted within the optical domain and ultimately delivered to other ToR switches. Furthermore, amplifiers are used to boost the power of the uploaded and downloaded optical signals, splitters and couplers are used to duplicate and combine signals, and wavelength-selective switches enable the selection of specific wavelengths and routing. Unlike prior technologies, where optical signals are transmitted to other optical switches without wavelength or route selection and are directly copied for further transmission, the proposed system enables precise selection of their corresponding transmission ports and wavelengths before transmission. This approach provides high flexibility, ultra-low latency, ultra-high bandwidth, and high energy efficiency during optical signal transmission, achieving high-performance inter-rack data communication.

To achieve the above objective, the present invention discloses an optical switch connected to a top-of-rack (ToR) switch for transmitting a plurality of optical signals between at least one vertically connected optical switch and at least one horizontally connected optical switch. The optical switch comprises an optical upload module, an optical download module, an optical pass-around module, and an optical fiber connection module. The optical fiber connection module is internally connected with the optical upload module, the optical download module and the optical pass-around module, and externally connected to the neighboring vertically connected optical switch and the horizontally connected optical switch, to facilitate the rack-to-rack transmission of the optical signals. The optical upload module receives a plurality of uploaded optical signals from the ToR switch, selects routes and wavelengths, and transmits the uploaded optical signals to the optical fiber connection module. The optical download module receives the optical signals from the at least one vertically connected optical switch and the at least one horizontally connected optical switch, selectively combines these signals, and downloads them to the ToR switch. The optical pass-around module, along with the optical fiber connection module, is used to redirect the optical signals from horizontal to vertical or from vertical to horizontal.

In one embodiment of the present invention, the optical upload module comprises a multiplexer, a first amplifier, a first splitter, a first vertical wavelength-selective switch, and a first horizontal wavelength-selective switch. The multiplexer receives the uploaded optical signals from the top-of-rack (ToR) switch and combines the uploaded optical signals to output a combined optical signal. The first amplifier amplifies the combined optical signal received from the multiplexer. The first splitter receives the combined optical signal amplified by the first amplifier and duplicates it to generate a first vertical optical signal and a first horizontal optical signal. The first vertical wavelength-selective switch receives the first vertical optical signal from the first splitter and outputs at least one first vertical output optical signal to the optical fiber connection module and then to the at least one vertically connected optical switch. The first horizontal wavelength-selective switch receives the first horizontal optical signal from the first splitter and outputs at least one first horizontal output optical signal to the optical fiber connection module and then to the at least one horizontally connected optical switch.

In one embodiment of the present invention, the optical pass-around module comprises a second vertical wavelength-selective switch, a second amplifier, a second horizontal wavelength-selective switch, a third horizontal wavelength-selective switch, a third amplifier, and a third vertical wavelength-selective switch. The second vertical wavelength-selective switch receives a plurality of wavelength-selectable vertical optical signals from the optical fiber connection module and outputs a first redirected combined optical signal. The second amplifier amplifies the first redirected combined optical signal received from the second vertical wavelength-selective switch. The second horizontal wavelength-selective switch receives the first redirected combined optical signal amplified by the second amplifier and outputs at least one second horizontal output optical signal to the optical fiber connection module and then to the at least one horizontally connected optical switch. The third horizontal wavelength-selective switch receives a plurality of wavelength-selectable horizontal optical signals from the optical fiber connection module and outputs a second redirected combined optical signal. The third amplifier amplifies the second redirected combined optical signal received from the third horizontal wavelength-selective switch. The third vertical wavelength-selective switch receives the second redirected combined optical signal amplified by the third amplifier and outputs at least one second vertical output optical signal to the optical fiber connection module and then to the at least one vertically connected optical switch.

In one embodiment of the present invention, the optical download

module comprises a fourth vertical wavelength-selective switch, a fourth horizontal wavelength-selective switch, a first coupler, a fourth amplifier, and a demultiplexer. The fourth vertical wavelength-selective switch receives the wavelength-selectable vertical optical signals from the optical fiber connection module and outputs a first vertical combined optical signal. The fourth horizontal wavelength-selective switch receives the wavelength-selectable horizontal optical signals from the optical fiber connection module and outputs a first horizontal combined optical signal. The first coupler receives and couples the first vertical combined optical signal from the fourth vertical wavelength-selective switch and the first horizontal combined optical signal from the fourth horizontal wavelength-selective switch to form a downloaded output optical signal. The fourth amplifier amplifies the downloaded output optical signal received from the first coupler. The demultiplexer receives the downloaded output optical signal amplified by the fourth amplifier and splits the downloaded output optical signal into a plurality of downloaded optical signals.

In one embodiment of the present invention, the optical fiber connection module comprises a plurality of second splitters and a plurality of third splitters. The second splitters receive at least one second vertical optical signal from the at least one vertically connected optical switch and then duplicate and output wavelength-selectable vertical optical signals to the second vertical wavelength-selective switch and the fourth vertical wavelength-selective switch. The third splitters receive at least one second horizontal optical signal from the at least one horizontally connected optical switch and then duplicate and output wavelength-selectable horizontal optical signals to the third horizontal wavelength-selective switch and the fourth horizontal wavelength-selective switch.

In one embodiment of the present invention, the optical fiber connection module comprises a vertical optical fiber connection network and a horizontal optical fiber connection network. The vertical optical fiber connection network connects the first vertical wavelength-selective switch and the third vertical wavelength-selective switch to receive the optical signals and transmit them to the at least one vertically connected optical switch. The vertical optical fiber connection network also connects to the second splitters for transmitting the optical signals from the at least one vertically connected optical switch. The horizontal optical fiber connection network connects the first horizontal wavelength-selective switch and the second horizontal wavelength-selective switch to receive the optical signals and transmit them to the at least one horizontally connected optical switch. The horizontal optical fiber connection network also connects to the third splitters for transmitting the optical signals from the at least one horizontally connected optical switch.

In one embodiment of the present invention, the top-of-rack (ToR) switch includes a plurality of wavelength-division multiplexing (WDM) transceivers, which are correspondingly connected to the optical switches to perform optical-to-electrical and electrical-to-optical signal conversion.

In addition, the present invention discloses an optical virtual-circuit-switching network system comprising a plurality of optical switches and a plurality of top-of-rack (ToR) switches. The optical switches are interconnected through a plurality of optical fibers, forming a plurality of optical network subsystems for transmitting optical signals. The optical network subsystems include at least one horizontal optical network subsystem formed by a plurality of horizontally connected optical switches and at least one vertical optical network subsystem formed by a plurality of vertically connected optical switches. Each optical switch comprises an optical upload module, an optical download module, an optical pass-around module, and an optical fiber connection module. The optical fiber connection module internally connects with the optical upload module, the optical download module and the optical pass-around module, and externally connected to the other neighboring vertically connected optical switch and the horizontally connected optical switch, to facilitate the transmission of the optical signals. The ToR switches include a plurality of wavelength-division multiplexing (WDM) transceivers that are correspondingly connected to the optical switches. The optical upload module receives a plurality of uploaded optical signals from the corresponding ToR switch, selects routes and wavelengths, and transmits the uploaded optical signals to the optical fiber connection module. The uploaded optical signals are then transmitted to at least one of the vertically connected optical switches in the at least one vertical optical network subsystem or at least one of the horizontally connected optical switches in the at least one horizontal optical network subsystem through the optical fiber connection module. The optical download module receives the optical signals from the at least one vertically connected optical switch and the at least one horizontally connected optical switch, selectively combines these signals, and downloads them to the ToR switch. The optical pass-around module, along with the optical fiber connection module, is used to redirect the optical signals from horizontal to vertical or from vertical to horizontal. The ToR switches perform optical-to-electrical and electrical-to-optical signal conversion via the WDM transceivers.

In one embodiment of the present invention, the optical virtual-circuit-switching network system further comprises a plurality of servers connected to the corresponding top-of-rack (ToR) switches, enabling data transmission via the optical switches.

In one embodiment of the present invention, the optical upload module comprises a multiplexer, a first amplifier, a first splitter, a first vertical wavelength-selective switch, and a first horizontal wavelength-selective switch.

The multiplexer receives the uploaded optical signals from the top-of-rack (ToR) switch and combines them to output a combined optical signal. The first amplifier amplifies the combined optical signal received from the multiplexer. The first splitter receives the combined optical signal amplified by the first amplifier and duplicates it to generate a first vertical optical signal and a first horizontal optical signal. The first vertical wavelength-selective switch receives the first vertical optical signal from the first splitter and outputs at least one first vertical output optical signal to the optical fiber connection module and then to the at least one vertically connected optical switch. The first horizontal wavelength-selective switch receives the first horizontal optical signal from the first splitter and outputs at least one first horizontal output optical signal to the optical fiber connection module and then to the at least one horizontally connected optical switch.

In one embodiment of the present invention, the optical pass-around module comprises a second vertical wavelength-selective switch, a second amplifier, a second horizontal wavelength-selective switch, a third horizontal wavelength-selective switch, a third amplifier, and a third vertical wavelength-selective switch. The second vertical wavelength-selective switch receives a plurality of wavelength-selectable vertical optical signals from the optical fiber connection module and outputs a first redirected combined optical signal. The second amplifier amplifies the first redirected combined optical signal received from the second vertical wavelength-selective switch. The second horizontal wavelength-selective switch receives the first redirected combined optical signal amplified by the second amplifier and outputs at least one second horizontal output optical signal to the optical fiber connection module and then to the at least one horizontally connected optical switch. The third horizontal wavelength-selective switch receives a plurality of wavelength-selectable horizontal optical signals from the optical fiber connection module and outputs a second redirected combined optical signal. The third amplifier amplifies the second redirected combined optical signal received from the third horizontal wavelength-selective switch. The third vertical wavelength-selective switch receives the second redirected combined optical signal amplified by the third amplifier and outputs at least one second vertical output optical signal to the optical fiber connection module and then to the at least one vertically connected optical switch.

In one embodiment of the present invention, the optical download module comprises a fourth vertical wavelength-selective switch, a fourth horizontal wavelength-selective switch, a first coupler, a fourth amplifier, and a demultiplexer. The fourth vertical wavelength-selective switch receives wavelength-selectable vertical optical signals from the optical fiber connection module and outputs a first vertical combined optical signal. The fourth horizontal wavelength-selective switch receives wavelength-selectable horizontal optical signals from the optical fiber connection module and outputs a first horizontal combined optical signal. The first coupler receives and couples the first vertical combined optical signal from the fourth vertical wavelength-selective switch and the first horizontal combined optical signal from the fourth horizontal wavelength-selective switch to form a downloaded output optical signal. The fourth amplifier amplifies the downloaded output optical signal received from the first coupler. The demultiplexer receives the downloaded output optical signal amplified by the fourth amplifier and splits it into a plurality of downloaded optical signals.

In one embodiment of the present invention, the optical fiber connection module comprises a plurality of second splitters and a plurality of third splitters. The second splitters receive at least one second vertical optical signal from the at least one vertically connected optical switch and then duplicate and output the wavelength-selectable vertical optical signals to the second vertical wavelength-selective switch and the fourth vertical wavelength-selective switch. The third splitters receive at least one second horizontal optical signal from the at least one horizontally connected optical switch and then duplicate and output the wavelength-selectable horizontal optical signals to the third horizontal wavelength-selective switch and the fourth horizontal wavelength-selective switch.

In one embodiment of the present invention, the optical fiber connection module comprises a vertical optical fiber connection network and a horizontal optical fiber connection network. The vertical optical fiber connection network connects the first vertical wavelength-selective switch and the third vertical wavelength-selective switch to receive the optical signals and transmit them to the at least one vertically connected optical switch. The vertical optical fiber connection network also connects to the second splitters for transmitting the optical signals from the at least one vertically connected optical switch. The horizontal optical fiber connection network connects the first horizontal wavelength-selective switch and the second horizontal wavelength-selective switch to receive the optical signals and transmit them to the at least one horizontally connected optical switch. The horizontal optical fiber connection network also connects to the third splitters for transmitting the optical signals from the at least one horizontally connected optical switch.

In one embodiment of the present invention, the number of optical switches in each optical network subsystem is denoted as N, and the number of optical network subsystems directly connected to each optical switch is denoted as S. The total number of optical switches in the system is equal to NS.

In one embodiment of the present invention, the optical fibers are ribbon fibers. The optical switches in the at least one horizontal optical network subsystem and the optical switches in the at least one vertical optical network subsystem are interconnected in a full-mesh topology using the ribbon fibers.

The detailed technology and preferred embodiments of the present invention are described in the following paragraphs, accompanied by the appended drawings, to enable those skilled in the art to fully understand the objectives, technical methods, and embodiments of the claimed invention.

### BRIEF DESCRIPTION OF THE DRAWINGS

FIG. 1 is a schematic view of the optical virtual-circuit-switching network system of the present invention;

FIG. 2 is a schematic view illustrating the relationship between the horizontal optical network subsystem and the vertical optical network subsystem of the present invention;

FIG. 3 is a schematic view of the optical switch of the present invention; and

FIG. 4 is a schematic diagram of the circuit in the optical switch of the present invention.

### DETAILED DESCRIPTION OF THE PREFERRED EMBODIMENT

The present embodiments of the invention will now be described in detail with reference to the accompanying drawings. These embodiments are provided for illustrative purposes only and are not intended to limit the present invention, its applications, or the particular implementations described herein.

Wherever applicable, the same reference numbers are used in the drawings and description to denote the same or similar components. It should be noted that, in the following embodiments and attached drawings, elements unrelated to the present invention have been omitted for simplicity, and the dimensional relationships among elements in the drawings are depicted for clarity of understanding rather than to represent actual scale.

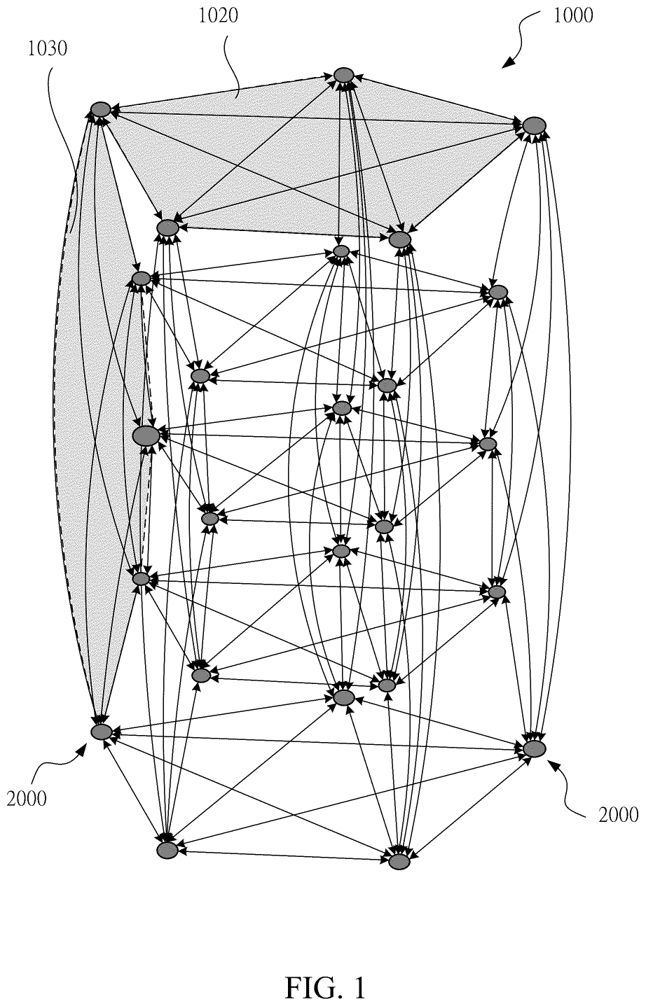

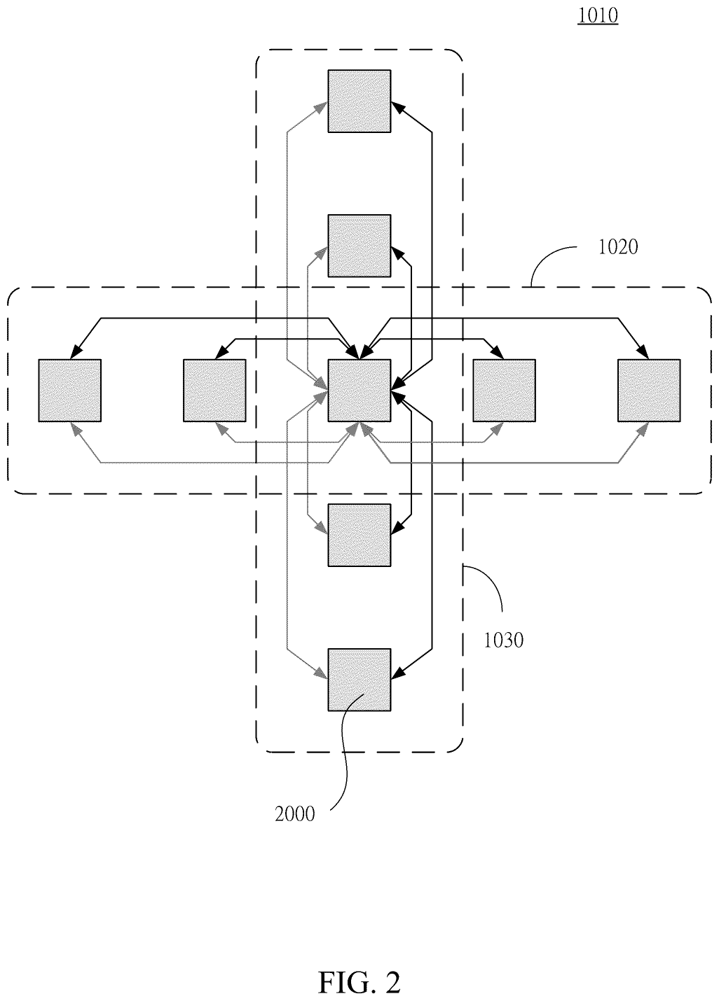

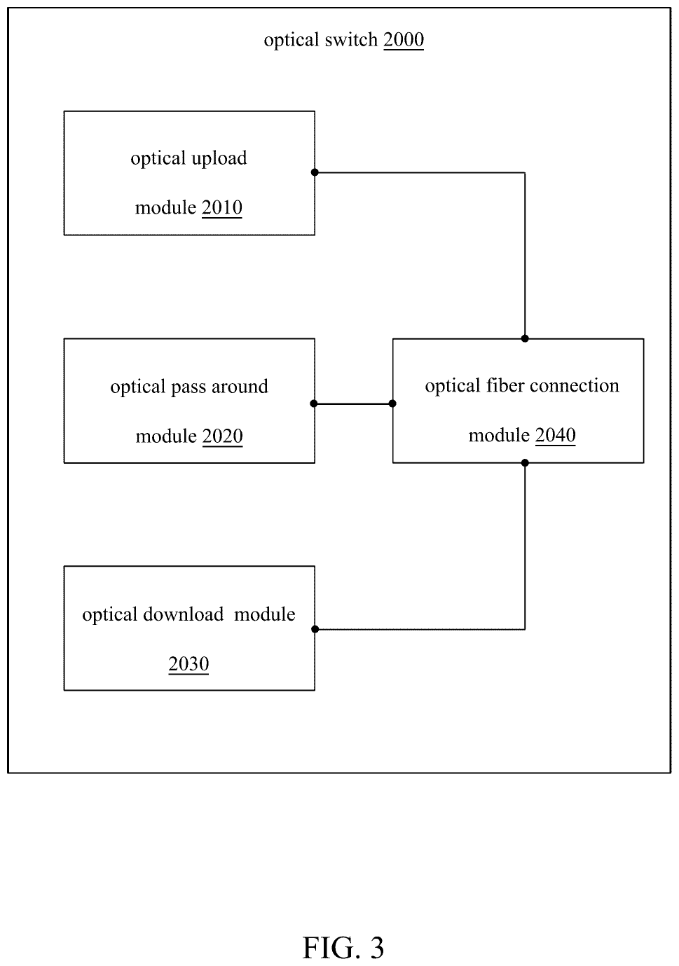

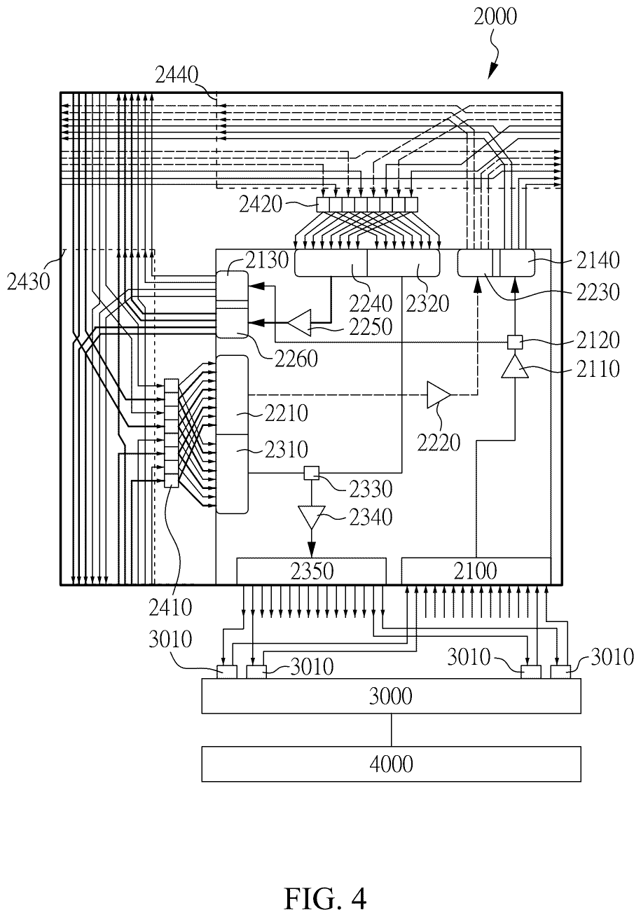

Please refer to FIG. 1 to FIG. 4. FIG. 1 illustrates an embodiment of the optical virtual-circuit-switching network system 1000 of the present invention. FIG. 2 is a schematic diagram showing the relationship between the horizontal optical network subsystem and the vertical optical network subsystem. FIG. 3 and FIG. 4 respectively depict a schematic diagram and a circuit diagram of the optical switch 2000. The optical virtual-circuit-switching network system 1000 comprises a plurality of optical switches 2000 and a plurality of top-of-rack (ToR) switches 3000. The optical switches 2000 are interconnected via a plurality of optical fibers to form multiple optical network subsystems 1010, wherein the optical fibers connecting the optical switches are ribbon fibers. Each optical switch 2000 is connected to a corresponding ToR switch 3000, and each ToR switch 3000 is connected to corresponding servers 4000. The ToR switches 3000 include a plurality of wavelength-division multiplexing (WDM) transceivers 3010 and are connected to the respective optical switches 2000. In other words, the number of optical switches 2000 in the optical virtual-circuit-switching network system 1000 is equal to the number of corresponding servers 4000 and ToR switches 3000. This configuration enables the servers 4000 to interconnect with each other via the optical switches 2000 and the ToR switches 3000, with a plurality of optical signals transmitted through the optical switches 2000.

The optical network subsystems 1010 comprise at least one horizontal optical network subsystem 1020 and at least one vertical optical network subsystem 1030. Each horizontal optical network subsystem 1020 is formed by a plurality of horizontally connected optical switches 2000, which are interconnected in a full-mesh topology via a first ribbon fiber (not shown). Similarly, each vertical optical network subsystem 1030 is formed by a plurality of vertically connected optical switches 2000, which are interconnected in the same full-mesh topology via a second ribbon fiber (not shown). In other words, each optical switch 2000 is connected to the other horizontally adjacent optical switches 2000 through the horizontal optical network subsystem 1020 and to the other vertically adjacent optical switches 2000 through the vertical optical network subsystem 1030.

In this embodiment, the number of optical switches in each optical network subsystem is referred to as the first quantity, and the number of optical network subsystems directly connected to each optical switch is referred to as the second quantity. The total number of optical switches is equal to the first quantity raised to the power of the second quantity. Specifically, the optical virtual-circuit-switching network system 1000 comprises NS optical switches 2000, where the first quantity (N) represents the number of optical switches 2000 in the horizontal optical network subsystem 1020 and the vertical optical network subsystem 1030 of each optical network subsystem 1010. The second quantity(S) represents the number of horizontal optical network subsystems 1020 and vertical optical network subsystems 1030 directly connected to each optical switch 2000. For example, as shown in FIG. 1, each optical switch 2000 in the optical virtual-circuit-switching network system 1000 is directly connected to both a horizontal optical network subsystem 1020 and a vertical optical network subsystem 1030 (i.e., S=2). The horizontal optical network subsystem 1020 and the vertical optical network subsystem 1030 each include five optical switches 2000 (i.e., N=5). Therefore, the optical virtual-circuit-switching network system 1000 consists of 5²=25 optical switches 2000. In other words, the optical virtual-circuit-switching network system 1000 has an architecture comprising five horizontal optical network subsystems 1020 and five vertical optical network subsystems 1030. It should be noted that the present invention allows for scaling the optical virtual-circuit-switching network system 1000 by increasing the number (N) of optical switches 2000 in the horizontal optical network subsystem 1020 and the vertical optical network subsystem 1030 of each optical network subsystem 1010 and/or by increasing the total number (S) of horizontal optical network subsystems 1020 and vertical optical network subsystems 1030 directly connected to each optical switch 2000. This flexibility enables the optical virtual-circuit-switching network system 1000 to adapt to various transmission requirements without any limitations on the number.

In this embodiment, the horizontal optical network subsystem 1020 and the vertical optical network subsystem 1030 include the same number of optical switches 2000. In the optical virtual-circuit-switching network system 1000, all optical switches 2000 are typically activated; however, specific optical switches 2000 may be selectively activated based on actual usage requirements. Additionally, if certain optical switches 2000 fail, causing some transmission paths to become unavailable, the software control function of Software-Defined Networking (SDN) can reroute the packet traffic to other available paths.

In detail, please refer again to FIG. 1 and FIG. 2. Each optical switch 2000 is connected to two sets of optical switches 2000 through the horizontal optical network subsystem 1020 and the vertical optical network subsystem 1030, respectively. Each optical switch 2000 connects to four adjacent optical switches 2000 in a full-mesh topology via the horizontal optical network subsystem 1020. Similarly, each optical switch 2000 connects to four adjacent optical switches 2000 in a full-mesh topology via the vertical optical network subsystem 1030. When the optical virtual-circuit-switching network system 1000 is handling packets, each optical switch 2000 can transmit or receive traffic through its connected horizontal optical network subsystem 1020 or vertical optical network subsystem 1030. Furthermore, the design focus of the optical switches 2000 is to enable efficient traffic transmission between the horizontal optical network subsystem 1020 and the vertical optical network subsystem 1030. This means that the optical switches 2000 can not only transmit traffic within their respective optical network subsystem but also route traffic from the horizontal optical network subsystem 1020 to the vertical optical network subsystem 1030, and vice versa. It should be noted that FIG. 2 illustrates only one set of horizontal optical network subsystem 1020 and one set of vertical optical network subsystem 1030 for demonstration purposes. In the optical virtual-circuit-switching network system 1000 of the present invention, all optical switches 2000 within each horizontal optical network subsystem 1020 and each vertical optical network subsystem 1030 are interconnected in a full-mesh topology. In other words, each optical switch 2000 is bidirectionally connected and supports bidirectional transmission.

Next, the configuration of the optical switches 2000 will be explained in detail. Please refer again to FIG. 3 and FIG. 4. Each optical switch 2000 comprises an optical upload module 2010, an optical pass-around module 2020, an optical download module 2030, and an optical fiber connection module 2040. The optical fiber connection module 2040 is internally connected to the optical upload module 2010, the optical pass-around module 2020, and the optical download module 2030, and is externally connected to the neighboring vertically connected optical switch and horizontally connected optical switch, to facilitate the transmission of optical signals. When optical signals are uploaded to an optical switch 2000 from the top-of-rack switch 3000, the optical upload module 2010 transmits the signals to another optical switch 2000 via the horizontal optical network subsystem 1020 or the vertical optical network subsystem 1030. These signals are then downloaded by the optical download module 2030 of the other optical switch 2000 to the top-of-rack switch 3000 of the corresponding optical switch 2000. Alternatively, the signals may continue to be redirected from the optical pass-around module 2020 of the other optical switch 2000 to the next optical switch 2000 through the horizontal optical network subsystem 1020 or the vertical optical network subsystem 1030. Similarly, these signals are eventually downloaded via the optical download module 2030 to the corresponding top-of-rack switch 3000.

Specifically, the optical upload module 2010 receives a plurality of optical signals from one of the top-of-rack switches 3000 and transmits them to the optical fiber connection module 2040 after selecting the route and wavelength. These signals are then transmitted to the optical download module 2030 of another optical switch 2000 through the optical fiber connection module 2040. The optical download module 2030 receives the optical signals, selects and combines them, and downloads them to the top-of-rack switch 3000 which is connected to the optical download module 2030 of this optical switch 2000. Instead of transmitting the optical signals to the optical download module 2030 of another optical switch 2000, the optical signals can also be transmitted to the optical pass-around module 2020 of the next horizontally or vertically connected optical switch 2000 and redirected to the vertically or horizontally connected optical switches through the optical fiber connection module 2040. The optical signals are subsequently downloaded by the optical download module 2030 of the next optical switch 2000 to its corresponding top-of-rack switch 3000. The optical pass-around module 2020, along with the optical fiber connection module 2040, is used to redirect the optical signals from horizontal to vertical or from vertical to horizontal, wherein the optical signals originate from at least one horizontally connected optical switch 2000 and at least one vertically connected optical switch 2000.

The optical upload module 2010 comprises a multiplexer 2100, a first amplifier 2110, a first splitter 2120, a first vertical wavelength-selective switch 2130, and a first horizontal wavelength-selective switch 2140.

Please refer to FIG. 3 and FIG. 4 again. The optical fiber connection module 2040 includes a plurality of second splitters 2410, a plurality of third splitters 2420, a set of vertical optical fiber connection network 2430, and a set of horizontal optical fiber connection network 2440.

First, the uploaded optical signals, regarded as local traffic, originate from the optical switch 2000 corresponding to the local server 4000 and are transmitted as the downloaded optical signals to another optical switch 2000 corresponding to the other servers 4000. The transmission path involves transmitting an electrical signal to the wavelength-division multiplexing (WDM) transceiver 3010 through the top-of-rack switch 3000, which is correspondingly connected to the server 4000. The WDM transceiver 3010 then converts the electrical signal into uploaded optical signals and transmits these signals to the multiplexer 2100. Each uploaded optical signal has a distinct wavelength, and the corresponding wavelengths are different from one another. It should be noted that once the uploaded optical signals enter the optical switch 2000, no optical-electrical or electrical-optical signal conversion is required throughout the entire signal transportation. This eliminates power consumption associated with signal conversion.

Following the above, the uploaded optical signals are combined by the multiplexer 2100 into a single combined optical signal, and the multiplexer 2100 then outputs the combined optical signal. The first amplifier 2110 receives and amplifies the combined optical signal from the multiplexer 2100. The first splitter 2120 receives the amplified combined optical signal from the first amplifier 2110 and duplicates it into two copies, forming a first vertical optical signal and a first horizontal optical signal. The first vertical wavelength-selective switch 2130 receives the first vertical optical signal from the first splitter 2120 and outputs at least one first vertical output optical signal to the vertical optical fiber connection network 2430 and then to at least one vertically connected optical switch 2000. The first horizontal wavelength-selective switch 2140 receives the first horizontal optical signal from the first splitter 2120 and outputs at least one first horizontal output optical signal to the horizontal optical fiber connection network 2440 and then to at least one horizontally connected optical switch 2000.

The first amplifier 2110 is an Erbium-doped Optical Fiber Amplifier (EDFA) designed to enhance the power of the combined optical signal. Optical signals gradually attenuate or experience interference during optical fiber transmission. The use of an EDFA enables direct amplification of the optical signal's power during transmission without requiring optical-to-electrical signal conversion. This compensates for power attenuation during the horizontal or vertical optical signal upload process.

For example, in the optical virtual-circuit-switching network system 1000 of the present invention, sixteen or thirty-two optical signals can be transmitted simultaneously. If the number of uploaded optical signals is sixteen, this represents sixteen optical signals with different wavelengths. Each corresponding channel can use optical signals of different wavelengths. Specifically, a splitter is typically used to divide a single optical signal into two or more optical signals. A splitter generally has one input port and two or more output ports, distributing the input optical signal to the output ports according to a specific splitting ratio. In the present invention, the first splitter 2120 is a one-input, two-output splitter that duplicates the amplified combined optical signal into two identical combined optical signals, forming a first vertical optical signal and a first horizontal optical signal. Each of these signals includes sixteen different wavelengths of combined optical signals. These signals are then transmitted to the first vertical wavelength-selective switch 2130 and the first horizontal wavelength-selective switch 2140, where the wavelength and route are selected. The optical signals are transmitted via the optical fiber connection module 2040 to the vertically connected optical switches 2000 or the horizontally connected optical switches 2000. After wavelength selection, two of the first horizontal output optical signals are transmitted to the two horizontally connected optical switches 2000 on the east side, while the other two are transmitted to the horizontally connected optical switches 2000 on the west side. Similarly, two of the first vertical output optical signals are transmitted to the two vertically connected optical switches 2000 on the north side, while the other two are transmitted to the vertically connected optical switches 2000 on the south side.

The wavelength-selective switch is used to select the wavelength and output port of transmitted optical signals, enabling dynamic configuration of arbitrary wavelengths. In the present invention, as shown in FIG. 4, the first vertical wavelength-selective switch 2130 and the first horizontal wavelength-selective switch 2140 are both 1×4 wavelength-selective switches, each with one input optical fiber port and four output optical fiber ports. The input optical fiber port of the first vertical wavelength-selective switch 2130 receives the first vertical optical signal comprising sixteen different wavelengths. These optical signals can be selectively routed by the first vertical wavelength-selective switch 2130 to at least one of the output optical fiber ports for vertical transmission as the first vertical output optical signals. Similarly, the input optical fiber port of the first horizontal wavelength-selective switch 2140 receives the first horizontal optical signal comprising sixteen different wavelengths. These optical signals can be selectively routed by the first horizontal wavelength-selective switch 2140 to at least one of the output optical fiber ports for horizontal transmission as the first horizontal output optical signals. It should be noted that the first vertical optical signal and the first horizontal optical signal, each comprising sixteen different wavelengths, can be transmitted through one to four output optical fiber ports based on actual transmission conditions and are not limited thereto.

Next, the optical pass-around module 2020 will be described, as shown in FIG. 4. The optical pass-around module 2020 comprises a second vertical wavelength-selective switch 2210, a second amplifier 2220, a second horizontal wavelength-selective switch 2230, a third horizontal wavelength-selective switch 2240, a third amplifier 2250, and a third vertical wavelength-selective switch 2260.

For example, the second vertical wavelength-selective switch 2210 receives a plurality of wavelength-selectable vertical optical signals from the vertical optical fiber connection network 2430 and outputs a first redirected combined optical signal. Then, the second amplifier 2220 amplifies the first redirected combined optical signal received from the second vertical wavelength-selective switch 2210. Finally, the second horizontal wavelength-selective switch 2230 receives the amplified first redirected combined optical signal from the second amplifier 2220 and outputs at least one second horizontal output optical signal to the horizontal optical fiber connection network 2440 and then to the at least one horizontally connected optical switch 2000. Through this transmission path, the optical signals transmitted in the vertical optical network subsystem 1030 are redirected for transmission in the horizontal optical network subsystem 1020. Similarly, the third horizontal wavelength-selective switch 2240 receives a plurality of wavelength-selectable horizontal optical signals from the horizontal optical fiber connection network 2440 and outputs a second redirected combined optical signal. Then, the third amplifier 2250 amplifies the second redirected combined optical signal received from the third horizontal wavelength-selective switch 2240. Finally, the third vertical wavelength-selective switch 2260 receives the amplified second redirected combined optical signal from the third amplifier 2250 and outputs at least one second vertical output optical signal to the vertical optical fiber connection network 2430 and then to at least one vertically connected optical switch 2000. Through this transmission path, the optical signals transmitted in the horizontal optical network subsystem 1020 are redirected for transmission in the vertical optical network subsystem 1030. It should be noted that the second amplifier 2220 and the third amplifier 2250 are both erbium-doped fiber amplifiers (EDFAs), used to enhance the power of the first and second redirected combined optical signals respectively, thereby compensating for power attenuation during the optical signal transmission process when redirecting from horizontal to vertical or vertical to horizontal.

In detail, as shown in FIG. 4, the second vertical wavelength-selective switch 2210 and the third horizontal wavelength-selective switch 2240 are both 8×1 wavelength-selective switches, each with eight input optical fiber ports and one output optical fiber port. The input optical fiber ports of the second vertical wavelength-selective switch 2210 receive wavelength-selectable vertical optical signals from the vertical optical fiber connection network 2430. Similarly, the input optical fiber ports of the third horizontal wavelength-selective switch 2240 receive the wavelength-selectable horizontal optical signals from the horizontal optical fiber connection network 2440.

Additionally, in this embodiment, the second horizontal wavelength-selective switch 2230 and the third vertical wavelength-selective switch 2260 are both 1×4 wavelength-selective switches, each with one input optical fiber port and four output optical fiber ports. The input optical fiber port of the second horizontal wavelength-selective switch 2230 receives the first redirected combined optical signal with sixteen different wavelengths. These optical signals can be selectively routed by the second horizontal wavelength-selective switch 2230 to at least one output optical fiber port for horizontal transmission as the second horizontal output optical signals. Similarly, the input optical fiber port of the third vertical wavelength-selective switch 2260 receives the second redirected combined optical signal with sixteen different wavelengths. These optical signals can be selectively routed by the third vertical wavelength-selective switch 2260 to at least one output optical fiber port for vertical transmission as the second vertical output optical signals. Both the second horizontal wavelength-selective switch 2230 and the third vertical wavelength-selective switch 2260 provide wavelength and route selection functionalities. The optical signals are transmitted via the optical fiber connection module 2040 to the vertically or horizontally connected optical switches 2000. After wavelength selection, two of the second horizontal output optical signals are transmitted to the two horizontally connected optical switches 2000 on the east side, while the other two are transmitted to the horizontally connected optical switches 2000 on the west side. Likewise, two of the second vertical output optical signals are transmitted to the two vertically connected optical switches 2000 on the north side, while the other two are transmitted to the vertically connected optical switches 2000 on the south side.

Next, the optical download module 2030 will be described, as shown in FIG. 4. The optical download module 2030 comprises a fourth vertical wavelength-selective switch 2310, a fourth horizontal wavelength-selective switch 2320, a first coupler 2330, a fourth amplifier 2340, and a demultiplexer 2350.

For example, the fourth vertical wavelength-selective switch 2310 receives the wavelength-selectable vertical optical signals from the vertical optical fiber connection network 2430 and outputs a first vertical combined optical signal. Similarly, the fourth horizontal wavelength-selective switch 2320 receives the wavelength-selectable horizontal optical signals from the horizontal optical fiber connection network 2440 and outputs a first horizontal combined optical signal. The first coupler 2330, a two-input one-output coupler, receives the first vertical combined optical signal and the first horizontal combined optical signal from the fourth vertical wavelength-selective switch 2310 and the fourth horizontal wavelength-selective switch 2320, respectively, and couples them to form a downloaded output optical signal. The fourth amplifier 2340 amplifies the downloaded output optical signal received from the first coupler 2330. Finally, the demultiplexer 2350 receives the amplified downloaded output optical signal from the fourth amplifier 2340 and splits it into a plurality of downloaded optical signals. These downloaded optical signals are then transmitted to the wavelength-division multiplexing transceivers 3010, which convert them into electrical signals and transmit the electrical signals to the other top-of-rack switch 3000. From there, the signals are further transmitted to the corresponding servers 4000, enabling packet transmission between different servers 4000. It should be noted that the fourth amplifier 2340 is also an erbium-doped fiber amplifier, used to enhance the power of the downloaded output optical signal, compensating for power attenuation during the optical signal download process.

Specifically, the fourth vertical wavelength-selective switch 2310 and the fourth horizontal wavelength-selective switch 2320 are both 8×1 wavelength-selective switches, each having eight input optical fiber ports and one output optical fiber port. The input optical fiber port of the fourth vertical wavelength-selective switch 2310 receives the wavelength-selectable vertical optical signals from the vertical optical fiber connection network 2430. The input optical fiber port of the fourth horizontal wavelength-selective switch 2320 receives the wavelength-selectable horizontal optical signals from the horizontal optical fiber connection network 2440.

For example, the second splitters 2410 receive at least one second vertical optical signal from at least one vertically connected optical switch 2000, and replicate and distribute the wavelength-selectable vertical optical signals to the second vertical wavelength-selective switch 2210 and the fourth vertical wavelength-selective switch 2310. Similarly, the third splitters 2420 receive at least one second horizontal optical signal from at least one horizontally connected optical switch 2000, and replicate and distribute the wavelength-selectable horizontal optical signals to the third horizontal wavelength-selective switch 2240 and the fourth horizontal wavelength-selective switch 2320.

In this embodiment, there are eight second splitters 2410, and each second splitter 2410 is a one-input, two-output splitter. Specifically, the input signals for the four second splitters 2410 in the optical download module 2030 come from at least one second vertical optical signal received from the vertically connected optical switch 2000 on the north side. These include the first vertical output optical signal and the second vertical output optical signal. Each second splitter 2410 replicates and outputs two identical wavelength-selectable vertical optical signals. Similarly, the input signals for the other four second splitters 2410 come from at least one second vertical optical signal received from the vertically connected optical switch 2000 on the south side, also including the first vertical output optical signal and the second vertical output optical signal. Each of these second splitters 2410 replicates and outputs two identical wavelength-selectable vertical optical signals. As a result, the second splitters 2410 collectively output sixteen wavelength-selectable vertical optical signals. At this stage, the second vertical wavelength-selective switch 2210 in the optical pass-around module 2020 can select specific wavelengths from the vertical optical signals to pass through, allowing the vertically transmitted optical signals to be redirected into horizontal transmission via the optical pass-around module 2020. Alternatively, the fourth vertical wavelength-selective switch 2310 in the optical download module 2030 can select specific wavelengths from the vertical optical signals to pass through, enabling the vertically transmitted optical signals to be downloaded to the connected top-of-rack switches 3000.

In this embodiment, there are eight third splitters 2420, and each third splitter 2420 is a one-input, two-output splitter. Specifically, the input signals of four third splitters 2420 in the optical download module 2030 are at least one second horizontal optical signal received from the horizontally connected optical switch 2000 on the east side. These signals include the first horizontal output optical signal and the second horizontal output optical signal. Each third splitter 2420 replicates and outputs two identical wavelength-selectable horizontal optical signals. The input signals of the other four third splitters 2420 are at least one second horizontal optical signal received from the horizontally connected optical switch 2000 on the west side. These signals also include the first horizontal output optical signal and the second horizontal output optical signal. Each of these third splitters 2420 replicates and outputs two identical wavelength-selectable horizontal optical signals. As a result, the third splitters 2420 collectively output a total of sixteen wavelength-selectable horizontal optical signals to the third horizontal wavelength-selective switch 2240 in the optical pass-around module 2020 and the fourth horizontal wavelength-selective switch 2320 in the optical download module 2030. The third horizontal wavelength-selective switch 2240 can select specific optical signals from the horizontal optical signals to pass through, allowing the horizontal transmission optical signals to be redirected into vertical transmission via the optical pass-around module 2020. Similarly, the fourth horizontal wavelength-selective switch 2320 can select specific optical signals from the horizontal optical signals to pass through, enabling the horizontal transmission optical signals to be downloaded via the optical download module 2030 to the connected top-of-rack switch 3000.

For example, the vertical optical fiber connection network 2430 connects the first vertical wavelength-selective switch 2130 and the third vertical wavelength-selective switch 2260 to receive the optical signals and transmit them to the at least one vertically connected optical switch 2000. The vertical optical fiber connection network 2430 also connects to the second splitter 2410 for transmitting the optical signals from the at least one vertically connected optical switch 2000. The horizontal optical fiber connection network 2440 connects the first horizontal wavelength-selective switch 2140 and the second horizontal wavelength-selective switch 2230 to receive the optical signals and transmit them to the at least one horizontally connected optical switch 2000. The horizontal optical fiber connection network 2440 also connects to the third splitter 2420 for transmitting the optical signals from the at least one horizontally connected optical switch 2000. Additionally, the vertical optical fiber connection network 2430 and the horizontal optical fiber connection network 2440 include multiple pass-through optical fibers, comprising four 12-core ribbon fiber bundles. Each of the 12-core ribbon fiber bundles is used for transmitting the optical signals in the east, west, south, and north directions, respectively. These ribbon fiber bundles are used to interconnect other vertically connected optical switches 2000 in a full-mesh topology, forming the vertical optical network subsystem 1030, and to interconnect other horizontally connected optical switches 2000 in a full-mesh topology, forming the horizontal optical network subsystem 1020.

The optical virtual-circuit-switching network system 1000 depicted in FIG. 1, the horizontal optical network subsystem 1020 and vertical optical network subsystem 1030 depicted in FIG. 2, and the optical switch 2000 depicted in FIG. 4 are provided as examples based on an optical virtual-circuit-switching network system 1000 composed of 25 optical switches 2000. It should be noted that the number of optical switches 2000 can be adjusted according to actual traffic transmission requirements. Similarly, the number of components within each optical switch 2000 and the number of ports per component can also be adjusted to correspond to the number of optical switches 2000 in the optical virtual-circuit-switching network system 1000, and is not limited thereto.

On the other hand, the quantities of amplifiers, splitters, wavelength- selective switches, and ribbon fibers can be adjusted based on the number of optical switches 2000 in the optical virtual-circuit-switching network system 1000, and is not limited thereto.

According to the above, the optical virtual-circuit-switching network system of the present invention is a distributed network architecture. The primary technical feature is the interconnection of multiple server racks through a plurality of optical switches, allowing packet traffic to be transmitted fully in the optical domain without the need of multiple optical-to-electrical and electrical-to-optical signal conversions. Each server rack is equipped with a top-of-rack switch and an optical switch, and interconnection between different server racks is achieved through horizontal optical network subsystems and vertical optical network subsystems formed by horizontally and vertically connected optical switches. Furthermore, each optical switch integrates essential components such as amplifiers, splitters/couplers, and wavelength-selective switches. These components collectively form the optical upload module, optical pass-around module, and optical download module, facilitating bidirectional transmission of optical signals between the horizontal and vertical optical network subsystems, thereby enabling efficient packet traffic transmission.

In addition, before the optical signals are transmitted from the optical upload module or the optical pass-around module to the optical fiber connection module for vertical or horizontal transmission, the appropriate wavelength and routing path can be selected through a one-input, four-output wavelength-selective switch, based on the routing requirements of the target optical switch. By employing this wavelength-selective switch and the newly designed transmission paths, the present invention enables precise selection of transmission ports and wavelengths for optical signals. This approach effectively eliminates signal interference and enhances transmission performance.

Although the present invention has been described in considerable detail with reference to certain embodiments thereof, other embodiments are possible. Therefore, the spirit and scope of the appended claims should not be limited to the description of the embodiments contained herein.

What is claimed is:

1. An optical switch, connected to a top-of-rack switch for transmitting a plurality of optical signals between at least one vertically connected optical switch and at least one horizontally connected optical switch, the optical switch comprising:
an optical upload module;
an optical download module;
an optical pass-around module; and
an optical fiber connection module internally connected to the optical upload module, the optical download module and the optical pass-around module, and externally connected to the at least one vertically connected optical switch and the at least one horizontally connected optical switch;
wherein the optical upload module receives a plurality of uploaded optical signals from the top-of-rack switch, selects routes and wavelengths, and transmits the uploaded optical signals to the optical fiber connection module;
the optical download module receives the optical signals from the at least one vertically connected optical switch and the at least one horizontally connected optical switch, and selectively combines and downloads the optical signals to the top-of-rack switch; and
the optical pass-around module, along with the optical fiber connection module, is used to redirect the optical signals from horizontal to vertical or from vertical to horizontal.

2. The optical switch of claim 1, wherein the optical upload module further comprises:
a multiplexer receiving the uploaded optical signals from the top-of-rack switch, and combining the uploaded optical signals to output a combined optical signal;
a first amplifier amplifying the combined optical signal received from the multiplexer;
a first splitter receiving the combined optical signal amplified by the first amplifier, and duplicating the combined optical signal amplified to generate a first vertical optical signal and a first horizontal optical signal;
a first vertical wavelength-selective switch receiving the first vertical optical signal from the first splitter, and outputting at least one first vertical output optical signal to the optical fiber connection module and then to the at least one vertically connected optical switch; and
a first horizontal wavelength-selective switch receiving the first horizontal optical signal from the first splitter, and outputting at least one first horizontal output optical signal to the optical fiber connection module and then to the at least one horizontally connected optical switch.

3. The optical switch of claim 2, wherein the optical pass-around module further comprises:
a second vertical wavelength-selective switch receiving a plurality of wavelength-selectable vertical optical signals from the optical fiber connection module, and outputting a first redirected combined optical signal;
a second amplifier amplifying the first redirected combined optical signal received from the second vertical wavelength-selective switch;
a second horizontal wavelength-selective switch receiving the first redirected combined optical signal amplified by the second amplifier, and outputting at least one second horizontal output optical signal to the optical fiber connection module and then to the at least one horizontally connected optical switch;
a third horizontal wavelength-selective switch receiving a plurality of wavelength-selectable horizontal optical signals from the optical fiber connection module, and outputting a second redirected combined optical signal;
a third amplifier amplifying the second redirected combined optical signal received from the third horizontal wavelength-selective switch; and
a third vertical wavelength-selective switch receiving the second redirected combined optical signal amplified by the third amplifier, and outputting at least one second vertical output optical signal to the optical fiber connection module and then to the at least one vertically connected optical switch.

4. The optical switch of claim 3, wherein the optical download module further comprises:
a fourth vertical wavelength-selective switch receiving the wavelength-selectable vertical optical signals from the optical fiber connection module, and outputting a first vertical combined optical signal;
a fourth horizontal wavelength-selective switch receiving the wavelength-selectable horizontal optical signals from the optical fiber connection module, and outputting a first horizontal combined optical signal;
a first coupler receiving and coupling the first vertical combined optical signal from the fourth vertical wavelength-selective switch and the first horizontal combined optical signal from the fourth horizontal wavelength-selective switch to form a downloaded output optical signal;
a fourth amplifier amplifying the downloaded output optical signal received from the first coupler; and
a demultiplexer receiving the downloaded output optical signal amplified by the fourth amplifier, and splitting the downloaded output optical signal into a plurality of downloaded optical signals.

5. The optical switch of claim 4, wherein the optical fiber connection module further comprises a plurality of second splitters and a plurality of third splitters, and wherein the second splitters receive at least one second vertical optical signal from the at least one vertically connected optical switch, and duplicate and output the wavelength-selectable vertical optical signals to the second vertical wavelength-selective switch and the fourth vertical wavelength-selective switch, and the third splitters receive at least one second horizontal optical signal from the at least one horizontally connected optical switch, and duplicate and output the wavelength-selectable horizontal optical signals to the third horizontal wavelength-selective switch and the fourth horizontal wavelength-selective switch.

6. The optical switch of claim 5, wherein the optical fiber connection module further comprises a vertical optical fiber connection network and a horizontal optical fiber connection network, and wherein the vertical optical fiber connection network connects the first vertical wavelength-selective switch and the third vertical wavelength-selective switch to receive the optical signals and transmit the optical signals to the at least one vertically connected optical switch, and connects to the second splitters for transmitting the optical signals from the at least one vertically connected optical switch, and wherein the horizontal optical fiber connection network connects the first horizontal wavelength-selective switch and the second horizontal wavelength-selective switch to receive the optical signals and transmit the optical signals to the at least one horizontally connected optical switch, and connects to the third splitters for transmitting the optical signals from the at least one horizontally connected optical switch.

7. The optical switch of claim 1, wherein the top-of-rack switch includes a plurality of wavelength-division multiplexing transceivers correspondingly connected to the optical switches to perform optical-to-electrical and electrical-to-optical signal conversion.

8. An optical virtual-circuit-switching network system, comprising:
a plurality of optical switches being interconnected through a plurality of optical fibers to form a plurality of optical network subsystems for transmitting a plurality of optical signals, wherein the optical network subsystems include at least one horizontal optical network subsystem formed by a plurality of horizontally connected optical switches and at least one vertical optical network subsystem formed by a plurality of vertically connected optical switches, each of the optical switches including an optical upload module, an optical download module, an optical pass-around module, and an optical fiber connection module, wherein the optical fiber connection module internally connects with the optical upload module, the optical download module and the optical pass-around module, and externally connect to the horizontally connected optical switches and the vertically connected optical switches; and
a plurality of top-of-rack switches including a plurality of wavelength-division multiplexing transceivers correspondingly connected to the optical switches;
wherein the optical upload module correspondingly receives a plurality of uploaded optical signals from the top-of-rack switch, selects routes and wavelengths, and transmits the uploaded optical signals to the optical fiber connection module, and then the uploaded optical signals are transmitted to at least one of the vertically connected optical switches in the at least one vertical optical network subsystem or to at least one of the horizontally connected optical switches in the at least one horizontal optical network subsystem through the optical fiber connection module;
the optical download module receives the optical signals from the at least one vertically connected optical switch and the at least one horizontally connected optical switch, and selectively combines and downloads the optical signals to the top-of-rack switch;
the optical pass-around module redirects the optical signals from horizontal to vertical or from vertical to horizontal; and
the top-of-rack switches enable optical-electrical and electrical-optical signal conversion via the wavelength-division multiplexing transceivers.

9. The optical virtual-circuit-switching network system of claim 8, further including a plurality of servers correspondingly connected to the top-of-rack switches to enable data transmission through the optical switches.

10. The optical virtual-circuit-switching network system of claim 8, wherein the optical upload module further comprises:
a multiplexer receiving the uploaded optical signals from the top-of-rack switch, and combining the uploaded optical signals to output a combined optical signal;
a first amplifier amplifying the combined optical signal received from the multiplexer;
a first splitter receiving the combined optical signal amplified by the first amplifier, and duplicating the combined optical signal amplified to generate a first vertical optical signal and a first horizontal optical signal;
a first vertical wavelength-selective switch receiving the first vertical optical signal from the first splitter, and outputting at least one first vertical output optical signal to the optical fiber connection module and then to the at least one vertically connected optical switch; and
a first horizontal wavelength-selective switch receiving the first horizontal optical signal from the first splitter, and outputting at least one first horizontal output optical signal to the optical fiber connection module and then to the at least one horizontally connected optical switch.

11. The optical virtual-circuit-switching network system of claim 10, wherein the optical pass-around module further comprises:
a second vertical wavelength-selective switch receiving a plurality of wavelength-selectable vertical optical signals from the optical fiber connection module, and outputting a first redirected combined optical signal;
a second amplifier amplifying the first redirected combined optical signal received from the second vertical wavelength-selective switch;
a second horizontal wavelength-selective switch receiving the first redirected combined optical signal amplified by the second amplifier, and outputting at least one second horizontal output optical signal to the optical fiber connection module and then to the at least one horizontally connected optical switch;
a third horizontal wavelength-selective switch receiving a plurality of wavelength-selectable horizontal optical signals from the optical fiber connection module, and outputting a second redirected combined optical signal;
a third amplifier amplifying the second redirected combined optical signal received from the third horizontal wavelength-selective switch; and
a third vertical wavelength-selective switch receiving the second redirected combined optical signal amplified by the third amplifier, and outputting at least one second vertical output optical signal to the optical fiber connection module and then to the at least one vertically connected optical switch.

12. The optical virtual-circuit-switching network system of claim 11, wherein the optical download module further comprises:
a fourth vertical wavelength-selective switch receiving the wavelength-selectable vertical optical signals from the optical fiber connection module, and outputting a first vertical combined optical signal;
a fourth horizontal wavelength-selective switch receiving the wavelength-selectable horizontal optical signals from the optical fiber connection module, and outputting a first horizontal combined optical signal;
a first coupler receiving and coupling the first vertical combined optical signal from the fourth vertical wavelength-selective switch and the first horizontal combined optical signal from the fourth horizontal wavelength-selective switch to form a downloaded output optical signal;
a fourth amplifier amplifying the downloaded output optical signal received from the first coupler; and
a demultiplexer receiving the downloaded output optical signal amplified by the fourth amplifier, and splitting the downloaded output optical signal into a plurality of downloaded optical signals.

13. The optical virtual-circuit-switching network system of claim 12, wherein the optical fiber connection module further comprises a plurality of second splitters and a plurality of third splitters, and wherein the second splitters receive at least one second vertical optical signal from the at least one vertically connected optical switch, and duplicate and output the wavelength-selectable vertical optical signals to the second vertical wavelength-selective switch and the fourth vertical wavelength-selective switch, and the third splitters receive at least one second horizontal optical signal from the at least one horizontally connected optical switch, and duplicate and output the wavelength-selectable horizontal optical signals to the third horizontal wavelength-selective switch and the fourth horizontal wavelength-selective switch.

14. The optical virtual-circuit-switching network system of claim 13, wherein the optical fiber connection module further comprises a vertical optical fiber connection network and a horizontal optical fiber connection network, and wherein the vertical optical fiber connection network connects the first vertical wavelength-selective switch and the third vertical wavelength-selective switch to receive the optical signals and transmit the optical signals to the at least one vertically connected optical switch, and connects to the second splitters for transmitting the optical signals from the at least one vertically connected optical switch, and wherein the horizontal optical fiber connection network connects the first horizontal wavelength-selective switch and the second horizontal wavelength-selective switch to receive the optical signals and transmit the optical signals to the at least one horizontally connected optical switch, and connects to the third splitters for transmitting the optical signals from the at least one horizontally connected optical switch.

15. The optical virtual-circuit-switching network system of claim 8, wherein a number of the optical switches in each of the optical network subsystems is denoted as N, a number of the optical network subsystems directly connected to each of the optical switches is denoted as S, and a total number of the optical switches is equal to NS.

16. The optical virtual-circuit-switching network system of claim 8, wherein the optical fibers are ribbon fibers, and the optical switches in the at least one horizontal optical network subsystem and the optical switches in the at least one vertical optical network subsystem are interconnected in a full-mesh topology using the ribbon fibers.
